(19) United States
(12) Patent Application Publication
(10) Pub. No.: US 2011/0031134 A1
(43) Pub. Date: Feb. 10, 2011

(54) ELECTROCHEMICAL ANTIOXIDANT SENSORS BASED ON METALLIC OXIDE MODIFIED ELECTRODES FOR THE GENERATION OF HYDROXYL RADICALS AND THE SUBSEQUENT MEASUREMENT OF ANTIOXIDANT ACTIVITIES

(75) Inventors: Philippe Tacchini, Geneva (CH); Grégoire Lagger, Geneva (CH); Hubert H. Girault, Lausanne (CH); Jifeng Liu, Lausanne (CH)

Correspondence Address: KNOBBE MARTENS OLSON & BEAR LLP, 2040 MAIN STREET, FOURTEENTH FLOOR, IRVINE, CA, 92614, US

(73) Assignee: EDEL THERAPEUTICS S.A., Lausanne (CH)

(21) Appl. No.: 12/680,725

(22) PCT Filed: Sep. 4, 2008
(86) PCT No.: PCT/EP08/07255

§ 371 Date: Sep. 21, 2010

(30) Foreign Application Priority Data
Sep. 28, 2007 (EP) PCT/EP2007/008491

(51) Int. Cl. G01N 27/26; B01J 21/00; B01J 23/44; G01N 27/403

(52) U.S. Cl. 205/785.5; 502/100; 502/339; 205/782; 204/412

(57) ABSTRACT

The present invention relates to a new antioxidant sensor based on metallic or metallic oxide modified electrode and its associated method for electrochemically generating hydroxyl radicals and their subsequent use for the electrochemical measurement of antioxidant activities based on hydroxyl radical scavenging properties of the tested sample.

### INTRODUCTION

The present invention relates to a new electrochemical sensors based on metallic oxide modified electrode and its associated method for generating hydroxyl radical and subsequently measuring antioxidant activity (radical hydroxyl scavenging activity) by electrochemistry in solution.

This invention is based on the deposition, including electro-deposition of a metal or metal oxide or any of their combinations onto a conductive substrate, their subsequent electro-reduction-oxidation, followed by cathodic polarization scans for generating the reduction of the metal or metal oxide concomitantly to the reduction of oxygen present in solution into hydrogen peroxide. The formed hydrogen peroxide dissimulates into hydroxyl radicals, which in turn can re-oxidize the metal into the metal oxide. The reduction of the metal oxide gives rise to a catalytic current which can be measured by electrochemistry. In presence of antioxidants, which will compete out—scavenged—the produced hydroxyl radicals, the catalytic current will be reduced. The antioxidant capacities—hydroxyl scavenging activities—are measured by electrochemistry by comparing the catalytic current with and without antioxidants.

In the recent past a variety of electrodes have been developed for detecting discrete molecules or measuring a biological activity. In general, such electrodes are required to exhibit a high specificity for the particular entity to be detected or determined, and a high sensitivity, so that even a low number/amount/activity of the specific entity may be detected.

Electrochemical sensors incorporating various electrodes and based on the measurements of the reducing power of the tested solutions have been described. These sensors can be used for measuring the ability of tested compounds to donate their electrons at increasing oxidizing potentials, but none of them provides the ability to generate hydroxyl radicals and to measure the hydroxyl radicals modifying and/or scavenging activity of the tested samples by electrochemistry.

The use of electrochemistry has been used for the evaluation of antioxidant capacity. Chevion et al, Free Radical Biology & Medicine, Vol. 28, No 6, pp 860-70, 2000, Korotkova et al., Journal of Electrochemical Chemistry 518, pp 56-60, 2002, Blasco et al, Analytica Chimia Acta, 511, pp 71-81, 2004, Psotova et al., Biomed Papers 145 (2), pp 81-83, 2001, and Kilmartin, Antioxidants & Redox Signaling, vol. 3, Number 6, pp 941-953, 2001, describe electrochemical based methods for measuring antioxidants activity but none of them describe the measurement of antioxidants with the generation and the use of hydroxyl radicals for measuring them.

U.S. Pat. No. 6,638,415 describes a device for measuring the level of an oxidant or anti-oxidant analyte in a fluid sample. The device is comprised in a disposable electrochemical cell containing a reagent capable of undergoing a redox reaction with the analyte. WO2004/044576 describes an electrochemical method for measuring oxidant/antioxidant activity based on the modification of the oxidation/reduction potential before and after the introduction of the substance to be analyzed in a specific solution containing a mediator pair. U.S. Pat. No. 5,239,258 describes a method for analyzing the oxidation product of the tested material. U.S. Pat. No. 5,518,590 describes an electrochemical sensor for measuring motor oil deterioration, including antioxidation properties with the use of two or three electrode and a conductive electrolyte liquid. U.S. Pat. No. 6,689,265 describes the use of enzyme for the detection and measurement of an analyte in a biofluid. U.S. Pat. No. 5,009,766 describe a metal oxide electrode for measuring ionic species. The sensors and associated methods describe in these patents do not include the generation of hydroxyl radicals nor their subsequent use for measuring the level of oxidant or antioxidant in a fluid sample.

Yang et al. (Electroanalysis 18, pp 64-69, 2005) describes the use of a Palladium nanoparticles modified electrodes for the reduction and determination of oxygen. This electrode was used for the determination of dissolved oxygen in solution but can not be used for the generation and subsequent use of hydroxyl radical for measuring antioxidant activity. Sarapuu et al (Electrochemical and Solid-State Letters, 8, (2), E30-E33, 2005 reported the reduction of oxygen on quinone modified electrodes in alkaline solution, but such modified electrodes can not be used for measuring antioxidant activities at physiological and neutral pH

No metallic oxide modified electrodes such as described here are used for electrochemical detection and measurement of antioxidant activities based on hydroxyl radical scavenging activities.

The present invention resides in the electrochemical generation of hydroxyl radical and the electrochemical detection of their consumption by the tested compounds, resulting in the measurements of their antioxidant activities—hydroxyl radical scavenging properties.

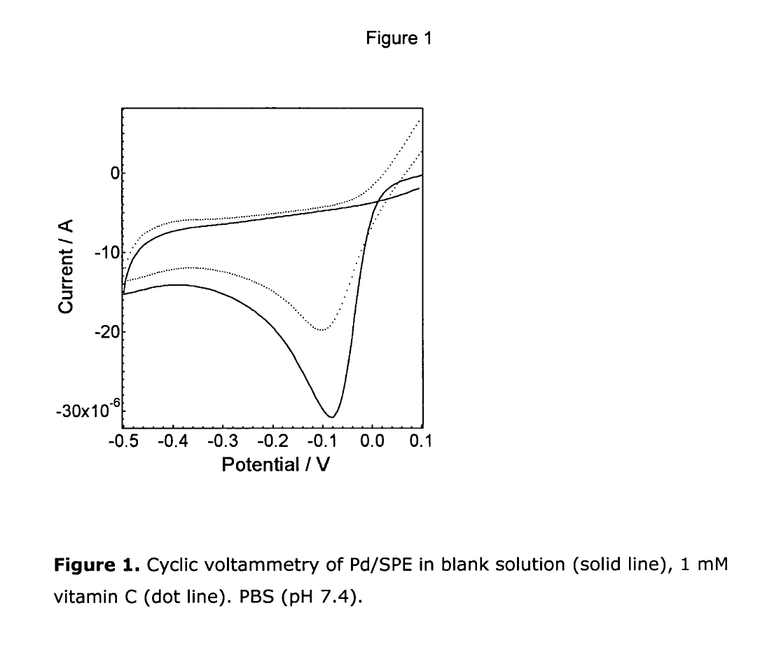

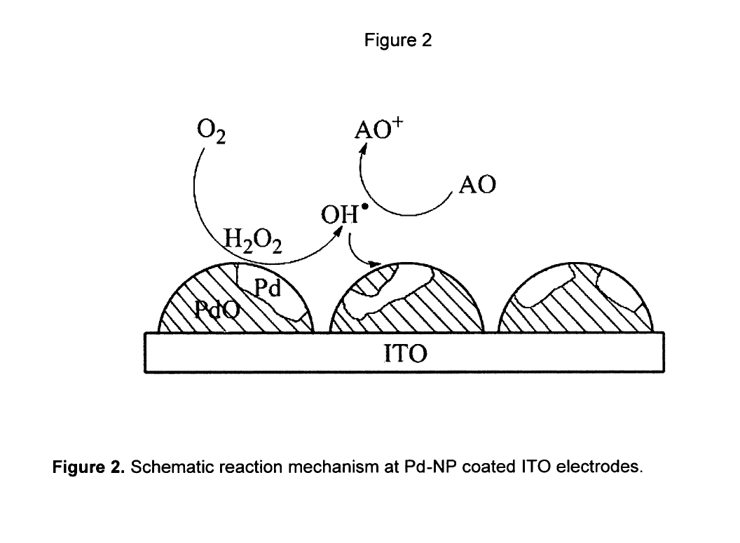

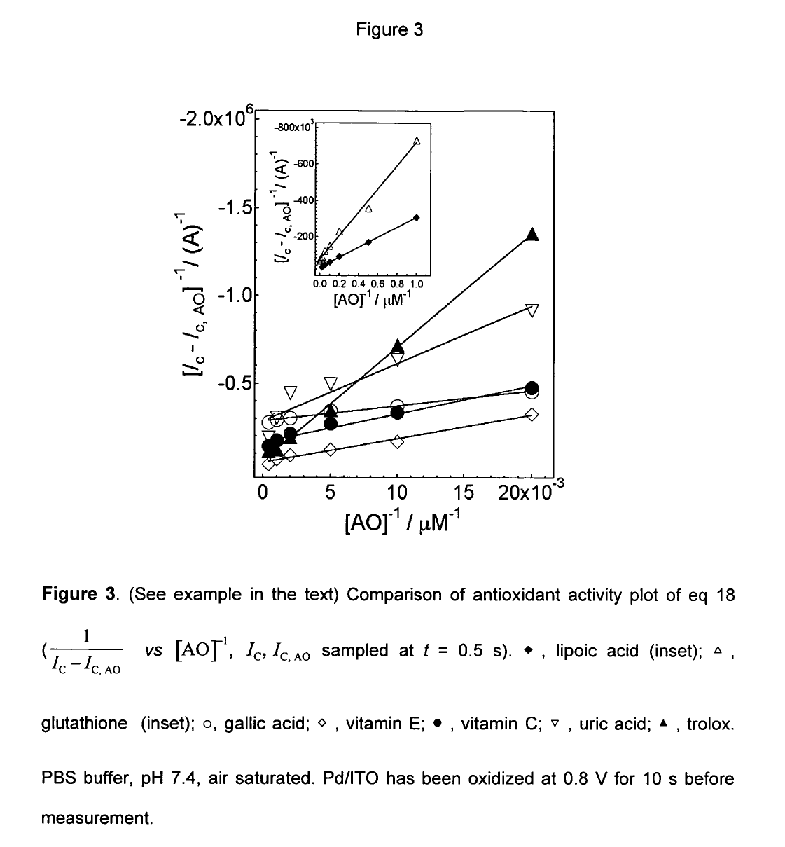

FIG. 1 shows the result of such a measurement with a) no antioxidant present and b) in presence of vitamin C with the disclosed invention. The Scheme 1 shows the steps of Reduction process occurring on the palladium coated electrode. The schematic reaction mechanism on the palladium coated electrode is shown on FIG. 2 and the FIG. 3 shows the comparison of antioxidant activity of several antioxidants, including lipoic acid glutathione, gallic acid, vitamin E, vitamin C, uric acid and trolox in PBS buffer at pH 7.4.

### Description of the Metallic Oxide Modified Electrodes

The present invention provides a metallic oxide modified electrode for the electrochemically controlled generation of hydroxyl radical and subsequent electrochemical detection of antioxidant activities based on hydroxyl radicals scavenging properties displayed by the tested compounds. This includes the method for the fabrication of metallic oxide modified sensor, incorporating the modified electrodes and their use for electrochemically generating hydroxyl radicals and electrochemically measuring antioxidant activities and/or scavenging antioxidant activity of tested compounds, such as antioxidants or pollutants.

### Production of the Modified Electrode

The metallic oxide modified electrode can be prepared according to either one or any combinations of the following methods.

1. Oxidizing a metal substrate such as palladium, platinum, ruthenium, rhodium, osmium, cobalt and Nickel, their respective oxide and their alloy and alloy oxide in any combinations in order to obtain a thin oxide film covering the metal.
2. Deposition of a nanofilm or nanoparticles of metallic oxide onto any conductive or semi-conductive substrate, typically carbon, graphite diamond or metallic based electrodes. The deposition can be realized by physisorption, chemisorption or electrochemical procedures. This latter consists of depositing increasing metal or metallic oxide materials by successive round of electro deposition. The number of cycles is comprised between 1 and 100 and the concentration of metal, for example, palladium is comprised between 1 micro molar and 1 molar. 3. Mixing of metallic oxide particles with any conductive paste or ink.

At the surface of the material thus obtained, some electro active particles are emerging above the binder material, and metallic or metallic oxide materials as well as dye or other molecules are available for further treatments, including mechanical treatment, light irradiation at any wavelength, UV, x-ray, photon treatments, other radioactive activations such as with alpha, β-particles or neutrons, chemical activation such as acidic or basic treatment, oxidation, electrochemical activation such as reduction, oxidation, biological, biochemical treatments or combination of these techniques.

All treatments may also be conducted at specific, geometrically well defined, locations on the surface of the electrode. In addition, other insulating or conductive materials, such as polymeric solutions, metallic layers, ink, glue, solvents, etc. may be deposited onto certain locations/regions/areas on the surface. Thus, a patterning of the surface of the electrode may be obtained. The area of the sensor may be controlled by a first printing stage, by the ink composition, by this adding of layers geometrically defined. Any step of printing or treatment may be repeated in all kinds of sequences. The metallic or metallic oxide material can be deposited onto isolating or conductive substrate.

The electrode material used for electrochemical analysis and described here consists of at least conductive particles such as carbon, gold, platinum or any metallic or metallic oxide materials, including palladium, platinum, ruthenium, rhodium, osmium, cobalt and Nickel, their respective oxide and their alloy and alloy oxide in any combinations and binding materials such as polymers and glues or a combination of all of the above.

The composite material is in liquid form and may be applied to any isolating or conductive substrate such as paper, inert materials, and can be used as such or molded into any shape or printed with common techniques such as screen printing, rotogravure printing, simple casting, ink jet.

### Electrochemical Methodology

The electrode may then be assembled into an electrochemical sensor, incorporating one, two or three additional electrodes and analyzed in an electrochemical cell by means of any colorimetric, voltammetric, amperometric, coulometric techniques or impedance analysis. The principle of the measurement, in case of hydroxyl radicals' reactive substances, is the following: Reactive Oxygen species (hydroxyl radicals, ROS) are generated by electrochemistry. When the device is subjected to a hydroxyl scavenging and/or modifying action, an electrochemical signature of this action is obtained, thus the modifying/protective action of all antioxidants present can be electrochemically measured. In absence of oxidizable substrates, the metal or metallic oxide reduction current will provide a reference value, while the presence of any oxidizable compounds will modify it. The modification of the electrochemical response of the sensor, due to the presence of an oxidizable substrate which electrochemical signal may be displayed in potential, in current, in impedance, in the quantity of charge transported across the sensor, or any combinations of these signals result in the generation of the electrochemical hydroxyl radical modifying and/or scavenging signature of the tested compounds, including antioxidants activity.

### Use and Applications

When using the sensor obtainable according to the above described method steps for measuring antioxidant activities, the sensor is contacted with the sample to be analyzed, i.e. a sample suspected to modify and/or alter, and/or react with an hydroxyl radical e.g. typically any compounds displaying hydroxyl radical scavenging properties (antioxidants).

In general, the sample may be in any form allowing contact with the sensor, e.g. the form of a solution, a gas or even in solid form.

The sensor and its associated electrochemical device may be used in the measurement of any radical hydroxyl modifying factors including physical, chemical, biochemical and biological factors by electrochemistry.

This results in the possibility to characterize a given antioxidant, or a mixture of antioxidants in e.g. liquids, gel and gases. Applications include the analysis of any substance capable of holding antioxidant molecules including biological fluids such as saliva, blood, plasma, urine tears sweat and any solution harboring radical scavenging activity, including drinks, foods, wastes and cosmetics samples.

### EXAMPLES

### Palladium Coating and Hydroxyl Radical Production

The Palladium coating is performed as follows: indium tin oxide (ITO) slides or graphite based electrodes are first washed by ultrasound for 10 minutes in water and rinsed sequentially with acetone and a solution of sodium hydroxide (1M). Drying is performed at room temperature. The washed electrodes are immersed into a solution of K₂PdCl (2.5M in 100 M K₂SO₄) and the PdCl²⁻ is then oxidized by applying a potential cycled from 1.1 to 1.5 Volt at a scan rate of 100 mV/s. Ag/AgCl and a platinum wire are used as the reference and counter electrodes respectively. The Palladium coated electrode is then cycled from 0.8 to −0.8 V at a scan rate of 500 mV/s into an air saturated borate solution (pH 11.3) for the generation of hydroxyl radicals. These are revealed by fluorescence emission using terephtalic acid as indicator.

### Chronoamperometry and Antioxidant Activity Measurements

The palladium electrode are electrochemically oxidized at 0.8 V for 10 s to form a palladium oxide layer and then a negative potential (−0.4 V, pH 7.4) is applied for 0.5 s in H₂O₂ or air saturated solutions. The obtained current/times curves are used for kinetic characterizations and chronoamperometry is also used to compare antioxidant activities. Before the antioxidant assay, the palladium coated electrode is electrochemically oxidized at 0.8 V for 10 seconds in a buffer solution to oxidize the palladium prior the measurement of the tested antioxidant into a PBS solution (pH 7.4). During the antioxidant assay, the Palladium electrode was polarized with a potential of −0.4 V, the current value recorded at 0.5 s is used for the characterization of the antioxidant activities.

The proposed reaction mechanism is summarized in scheme 1 where k₀ is the electrochemical rate constant for the reduction of palladium oxide, k₁ is the dissociation rate constant of H₂O₂, k₂ is a second order rate constant, k₃, k₄ are the electrochemical rate constants for the reduction of OH*, H₂O₂, respectively. We shall call θ and 1-θ the surface coverage of PdO and Pd respectively. According to Scheme 1, we consider a kinetic model for a reaction layer close to the interface for which we shall neglect in a first approximation mass transfer, so that the rate law for the production of [OH*] is then simply

$$\frac{d [ {OH}^{•} ]}{d t} = - {k}_{2} [ {OH}^{•} ] ( 1 - θ ) + {k}_{1} [ {H}_{2} {O}_{2} ] ( 1 - θ ) - {k}_{4} [ {OH}^{•} ] \qquad ( 1 )$$

The steady state approximation for the OH radical yields

$$[ {OH}^{•} ] = \frac{{k}_{1} ( 1 - θ )}{{k}_{2} ( 1 - θ ) + {k}_{4}} [ {H}_{2} {O}_{2} ] \qquad ( 2 )$$

The variation of Pd surface coverage is then given by

$$\frac{d θ}{d t} = {k}_{2} [ {OH}^{•} ] ( 1 - θ ) - {k}_{0} θ = \frac{{k}_{1} {k}_{2} [ {H}_{2} {O}_{2} ] {( 1 - θ )}^{2}}{{k}_{2} ( 1 - θ ) + {k}_{4}} - {k}_{0} θ \qquad ( 3 )$$

In the short time limit when q<<1, then eq 3 reduces to

$$\frac{d θ}{d t} = \frac{{k}_{1} {k}_{2} [ {H}_{2} {O}_{2} ]}{{k}_{2} + {k}_{4}} - {k}_{0} θ \qquad ( 4 )$$

and the variation of the surface coverage of PdO with respect to time upon application of a potential step is

$$θ = \frac{{k}_{1} {k}_{2} [ {H}_{2} {O}_{2} ]}{{k}_{0} ( {k}_{2} + {k}_{4} )} [ 1 - {e}^{- {k}_{0} t} ] + {e}^{- {k}_{0} t} \qquad ( 5 )$$

In this case, the catalytic cathodic current I_{c} associated to the reduction of PdO and H₂O₂ reads

$${I}_{c} = {k}_{0} θ + {k}_{3} [ {H}_{2} {O}_{2} ] = [ {H}_{2} {O}_{2} ] [ \frac{{k}_{1} {k}_{2}}{{k}_{2} + {k}_{4}} [ 1 - {e}^{- {k}_{0} t} ] + {k}_{3} ] + {k}_{0} {e}^{- {k}_{0} t} \qquad ( 6 )$$

This equation corroborates the proportionality observed between the sampled current and the concentration of H₂O₂ at short times. In presence of dissolved oxygen, O₂ can be reduced to H₂O₂

$${O}_{2} + {H}_{2} O + 2 {e}^{-} {->}^{{k}_{r}} {H}_{2} {O}_{2} + 2 {OH}^{-}$$

where kᵣ is the electrochemical reduction rate constant. The oxygen reduction includes a series of elementary steps involving multi-electron transfers and different reaction intermediates. Oxygen adsorbed on palladium metal is reduced either to H₂O through a 4e⁻ reduction pathway or reduced to H₂O₂ through 2e⁻ reduction mechanism. In either case, the rate-determining step is likely to be the addition of the first electron to O₂ adsorbed to form a superoxide radical. The oxygen reduction is electro catalyzed by Pd in alkaline solutions. H₂O₂ is either further reduced to H₂O or dissociates to OH radical on palladium or platinum and platinum alloy clusters and surfaces. This oxygen reduction reaction forming ROS is at the basis of the antioxidant sensor proposed here as shown in FIG. 2.

Fluorescence measurements as above show an emission peak at 425 nm when Pd—NP coated ITO electrodes were immersed in air-saturated borate buffer solution containing TA and repeatedly scanned from 0.8 to −0.8V. In argon degassed solution, the fluorescence signal becomes negligible showing that the reduction of dissolved oxygen generates OH radicals at the electrode. When the Pd—NP coated ITO electrodes were scanned only from 0 to 0.8 V, no fluorescence could also be detected, as the palladium oxide is not reduced at these positive potentials. When cycling only at more negative potentials (0 to −0.8V), the palladium remained in a reduced state, and no OH radical was detected also. When PBS solution at pH=7.4 was used for cycling the electrode from 0.8 to −0.5V, the generation of OH radicals was also observed and the fluorescence intensity was comparable to that observed at pH=11.3. This suggests that oxygen reduction takes place at palladium sites that become freshly available upon palladium oxide reduction. In the other words, it would appear that only freshly formed i.e. newly reduced palladium site are active for oxygen reduction to generate OH radicals.

The steady-state approximation for the [H₂O₂] formed from O₂ reduction yields

$$\frac{d [ {H}_{2} {O}_{2} ]}{d t} = {k}_{r} [ {O}_{2} ] - {k}_{1} [ {H}_{2} {O}_{2} ] ( 1 - θ ) - {k}_{3} [ {H}_{2} {O}_{2} ] = 0 \qquad ( 7 )$$

Considering that we work in a basic buffer, we can assume that k₁(1−θ)>>k₃ and then

$$[ {H}_{2} {O}_{2} ] = \frac{{k}_{r} [ {O}_{2} ]}{{k}_{1} ( 1 - θ )} \qquad ( 8 )$$

In this case, the cathodic current associated to the reduction of PdO and O₂ reads

$${I}_{c} = {k}_{0} θ + {k}_{3} [ {H}_{2} {O}_{2} ] = {k}_{r} [ {O}_{2} ] [ \frac{{k}_{2}}{{k}_{2} + {k}_{4}} [ 1 - {e}^{- {k}_{0} t} ] + \frac{{k}_{3}}{{k}_{1}} ] + {k}_{0} {e}^{- {k}_{0} t} \qquad ( 9 )$$

The catalytic enhancement of palladium oxide reduction in the presence of dissolved oxygen was observed in chronoamperometry. Of course, it is difficult to vary the concentration of dissolved oxygen, but the current response should be similar to that obtained in the presence of hydrogen peroxide.

### Antioxidant Activity Measurement

The Pd—NP coated ITO electrode can be used as an antioxidant (AO) sensor if the antioxidant is able to compete for the scavenging of the ROS. If we consider the quenching of OH radical by AO

$${OH}^{*} + AO {->}^{{k}_{AO}} {H}_{2} O + {AO}^{+}$$

We can write that in presence of AO and dissolved O₂ the steady state approximation for the concentration of OH radicals

$$\frac{d [ {OH}^{*} ]}{d t} = {k}_{1} [ {H}_{2} {O}_{2} ] ( 1 - θ ) - {k}_{2} [ {OH}^{*} ] ( 1 - θ ) - {k}_{4} [ {OH}^{*} ] - {k}_{AO} [ {OH}^{*} ] [ AO ] = 0 \qquad ( 9 )$$

which gives

$$[ {OH}^{*} ] = \frac{{k}_{r} [ {O}_{2} ]}{{k}_{2} ( 1 - θ ) + {k}_{4} + {k}_{AO} [ AO ]} \qquad ( 10 )$$

and the variation of surface coverage of PdO is

$$\frac{d θ}{d t} = {k}_{2} [ {OH}^{*} ] ( 1 - θ ) - {k}_{0} θ = \frac{{k}_{2} {k}_{r} [ {O}_{2} \} ( 1 - θ )}{{k}_{2} ( 1 - θ ) + {k}_{4} + {k}_{AO} [ AO ]} - {k}_{0} θ \qquad ( 11 )$$

in the short time limit when q<<1, eq 11 reduces to

$$\frac{d θ}{d t} = \frac{{k}_{2} {k}_{r} [ {O}_{2} ]}{{k}_{2} + {k}_{4} + {k}_{AO} [ AO ]} - {k}_{0} θ \qquad ( 12 )$$

and the surface coverage of PdO reads

$$θ = \frac{{k}_{2} {k}_{r} [ {O}_{2} ]}{{k}_{0} ( {k}_{2} + {k}_{4} + {k}_{AO} [ AO ] )} [ 1 - {e}^{- {k}_{0} t} ] + {e}^{- {k}_{0} t} \qquad ( 13 )$$

In presence of AO and dissolved O₂, the catalytic reduction of Pd/ITO can be expressed as

$${I}_{AO} = {k}_{0} θ + {k}_{3} [ {H}_{2} {O}_{2} ] = {k}_{r} [ {O}_{2} ] [ \frac{{k}_{2}}{{k}_{2} + {k}_{4} + {k}_{AO} [ AO ]} [ 1 - {e}^{- {k}_{0} t} ] + \frac{{k}_{3}}{{k}_{1}} ] + {k}_{0} {e}^{- {k}_{0} t} \qquad ( 14 )$$

When comparing the current transient in the presence and absence of antioxidants, we have substitution of eq 9 and 14

$$\begin{matrix}{I}_{c} - {I}_{c , AO} = {k}_{r} {k}_{2} [ {O}_{2} ] [ \frac{1}{{k}_{2} + {k}_{4}} - \frac{1}{{k}_{2} + {k}_{4} + {k}_{AO} [ AO ]} ] [ 1 - {e}^{- {k}_{0} t} ] & ( 16 ) \\ I = K [ \frac{1}{A} - \frac{1}{A + {k}_{AO} [ AO ]} ] & \\ \frac{1}{I} = \frac{A}{K} \frac{A + {k}_{AO} [ AO ]}{{k}_{AO} [ AO ]} = \frac{A}{K} [ 1 + \frac{A}{{k}_{AO} [ AO ]} ] & ( 17 ) \\ \frac{1}{{I}_{c} - {I}_{c , AO}} = \frac{{k}_{2} + {k}_{4}}{{k}_{r} {k}_{2} [ {O}_{2} ] [ 1 - {e}^{- {k}_{0} t} ]} [ 1 + \frac{{k}_{2} + {k}_{4}}{{k}_{AO} [ AO ]} ] & ( 18 )\end{matrix}$$

So from eq 18, in presence of AO, the limiting current of catalytic palladium reduction will be decreased and this has been observed in chronoamperometry, the current is lower when antioxidant capacity is higher and

$$\frac{1}{{I}_{C} - {I}_{C , AO}}$$

is linear with [AOT]⁻¹ for AOs.

From eq 18, the slope values can be used to compare antioxidant activity and AO with smaller slope value has higher antioxidant activity. We can compare antioxidant activity of AOs. the antioxidant activity decreases in the order: lipoic acid, glutathione, gallic acid, vitamin E, vitamin C, uric acid, trolox. Their slope values read are −2.77×10⁵, −6.46×10⁵, −8.59×10⁶, −1.35×10⁷, −1.60×10⁷, −3.26×10⁷, −6.45×10⁷, respectively (see FIG. 3).

1. An electrode used for determining the hydroxyl radical scavenging properties of antioxidants in an aqueous solution comprising a catalyst able to generate hydroxyl radicals during a cathodic polarisation in an aqueous solution containing hydrogen peroxide or dissolved oxygen, and yielding a catalytic current sensitive to the presence of antioxidants in the solution.

2. An electrode, according to claim 1, where the catalyst is a redox molecule grafted or adsorbed on the electrode that provides a catalytic current upon its reduction in the aqueous solution containing the hydrogen peroxide or the dissolved oxygen that is sensitive to the presence of the antioxidants in the solution.

3. An electrode, according to claim 1, where the catalyst is made of metal oxide particles selected from the group consisting of palladium oxide, platinum oxide, ruthenium oxide, osmium oxide, cobalt oxide, nickel oxide or any metal oxide that provides a catalytic current upon reduction of the oxide in the aqueous solution containing the hydrogen peroxide or the dissolved oxygen that is sensitive to the presence of the antioxidants in the solution.

4. An electrode according to claim 1, where a modified electrode material can be any conductive compound, any metal or metal oxide, graphite based material or any of their combinations.

5. A method for determining the hydroxyl radical scavenging properties of antioxidants in an aqueous solution containing hydrogen peroxide or dissolved oxygen which comprises:
generating hydroxyl radical through cathodic polarization on the catalytic electrode according to claim 1,
measuring a reduction catalytic current in the aqueous solution containing the hydrogen peroxide or the dissolved oxygen in the presence and in the absence of the antioxidants

6. A method according to claim 5 where the hydrogen peroxide is either added to the aqueous solution to be measured or generated in the aqueous solution by electrochemical reduction of the dissolved oxygen.

7. An antioxidant sensor comprising the catalytic electrode according to claim 1, a reference electrode and a counter electrode.

8. An apparatus for measuring antioxidant activity comprising a sensor according to claim 7, an electronic circuit able to apply a voltage signal between −5 to +5 Volt, and measuring a current between 1 Pico ampere and 1 ampere.

9. A method according to claim 5, wherein the antioxidant activities correspond to the hydroxyl radical scavenging activities of the tested antioxidants, including hydrogen transfer events between the tested antioxidants and the hydroxyl radicals.

10. A method for the expression of antioxidant activities according to claim 9, wherein the antioxidant activities is are expressed by a mathematical treatment which includes use of a ratio of the cathodic current with and without antioxidants, ICAOX IC, respectively.

11. A method for the expression of antioxidant activities according to claim 9, wherein an electrochemical measurement of antioxidant activities, including hydroxyl radical scavenging activities, is performed in acidic, physiological (neutral) or basic solution, which pH is comprised between 3 and 11.

12. A method according to claim 5, wherein the aqueous solution is selected from the group consisting of a biological fluid liquid food, a drink, cosmetics.

13. An electrode according to claim 3, wherein the catalyst is in a form of nanoparticle or layer.

14. An electrode according to claim 4, wherein said conductive compound is indium tin oxide.

15. An electrode according to claim 4, wherein said metal or metal oxide is selected from the group consisting of gold, platinum, and silver.

16. An electrode according to claim 4, wherein said graphite based material is screen printed carbon.

17. A method according to claim 12, wherein the biological solution is selected from the group consisting of saliva, blood, tears, and urine.
